(19) United States
(12) Patent Application Publication
(10) Pub. No.: US 2016/0041994 A1
(43) Pub. Date: Feb. 11, 2016

(54) METHODS FOR CONVERTING TEXT FILES

(71) Applicant: Tablo Pty Ltd, Richmond (AU)

(72) Inventor: Ashley DAVIES, Wheelers Hill (AU)

(21) Appl. No.: 14/819,524

(22) Filed: Aug. 6, 2015

Related U.S. Application Data
(60) Provisional application No. 62/033,687, filed on Aug. 6, 2014.

(51) Int. Cl. G06F 17/30; G06F 17/21

(52) U.S. Cl. CPC G06F 17/30076; G06F 17/30106; G06F 17/30011; G06F 17/212; G06F 17/218

(57) ABSTRACT

A computer-implemented method for converting a word processor document to an electronic book format for publication. The method includes analysing the word processor document for characteristics such as words or terms that are naturally used by an author in the preparation of a manuscript, and also structural characteristics of the word processor document such as page breaks, section breaks, cardinal or ordinal indicators and the like. Also provided is software configured to execute the method by way of a computer.

### FIELD OF THE INVENTION

The present invention is directed to the conversion of electronic text files into a format suitable for electronic publishing. In particular, but not exclusively, the invention provides methods for the conversion of a word processor file into a digital book format.

### BACKGROUND TO THE INVENTION

Electronic publishing has revolutionized the way in which books, manuals, and other documents are produced and distributed. Authors are now able to bypass traditional publishing houses and sell their books online in digital format through virtual retailers such as Amazon.com Kindle Store™, Apple iBooks™, Barnes & Noble™, Kobo™, OverDrive™, Flipkart™, Oyster™, Scribd™, Baker & Taylor's™ BIio™ and Axis360™.

A problem in the art is the conversion of an authors' manuscript in a word processor file format into an electronic book (“ebook”) format. Retailers require well formatted and validated ebooks which are readable by devices such as a Kindle™ (using native software) or by generic devices such as tablets via downloadable Android™ or iOS™ applications. Indeed, many authors seeking to have their ebook listed with one of the major retailers are often rejected for the reason of a poorly formatted book.

Authors do not naturally write according to any predetermined format, and so methods for the conversion of word processor documents into ebooks are confounded by the many and varied ways that a book may be structured (or indeed unstructured) by an author.

In particular, it is difficult for an automated conversion engine to define where particular sections of a book begin (such as chapters). Authors segment chapters in many ways on a word processor and may, for example, use bolded or italicised text for a chapter title, centred text, a larger font, a different font, underlining and the like. Accordingly, prior art conversion engines often fail to detect chapter breaks leading to a poorly formatted ebook. The presence of other sections in a book such as the preface, title page, index and the like complicate the identification of chapter breaks, and should themselves be presented properly in ebook format.

Given the shortcoming in prior art conversion methods, some companies (such as Smashwords, Inc.) have gone to great lengths to provide a conversion engine capable of generating well formatted ebooks from word processor files. One example is the engine provided by Smashwords, Inc. In order to utilize the Smashwords™ conversion engine, the author must write in strict conformance with a specific style guide issued by the company. The style guide is over 100 pages long, and of significant complexity. Furthermore, different instructions for formatting are given according to the different versions of word processing software used by the author. For many authors, strict conformance with the style is simply too onerous, with some taking the option of employing an expert company to format their manuscript.

Despite recent improvements in Smashwords™ conversion engine, there is still a large margin of error with many output documents requiring significant amendment to be readable.

The conversion process can be so difficult that some professional eBook converters such as eBook Architects do not offer to generate a Smashwords™ source file.

It is an aspect of the present invention to overcome or ameliorate a problem of the prior art to provide an improved method for the conversion of text files to ebook files. Alternatively, it is an aspect of the present invention to provide a useful alternative to prior art text conversion methods.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each provisional claim of this application

### SUMMARY OF THE INVENTION

In a first aspect, the present invention provides a computer-implemented method for converting a source file having a first format into a target file having a second format, the method comprising the step of providing a source file, and analysing the source file to identify one or more file structure characteristics.

In one embodiment, one of the one or more file structure characteristics is a section break.

In one embodiment, the method comprises the step of searching the complete source file for the presence or absence of page breaks, wherein the section break is identified by the presence of 3 or more page breaks in the source file, with each of the 3 or more page breaks being taken as indicative of a section break.

In one embodiment, one of the one or more file structure characteristics is a top level heading tag embedded in the source file.

In one embodiment, one of the one or more file structure characteristics is a new line or a paragraph commencing with or comprising a natural term that is indicative of a section break.

In one embodiment, the natural term is selected from the group consisting of “chapter”, “section”, “part”, “module”, “prologue”, “epilogue”, “preface”, “foreword”, “introduction”, “acknowledgement”, “dedication”, “copyright”, “rights reserved”, “index”, “contents”, “afterword”, “conclusion”, “postscript”, “appendix”, “addendum”, “annex”, “glossary”, “references” and “bibliography”, or linguistic equivalent thereof.

In one embodiment, one of the one or more file structure characteristics is a new line or a paragraph commencing with or comprising a cardinal or ordinal indicator that is indicative of a section break.

In one embodiment, the ordinal indicator is a numeral, or a term.

In one embodiment, the numeral is an integer; and the term is “first”, “second”, or “third”; or “1st”, “2nd”, or “3rd”.

In one embodiment, one of the one or more file structure characteristics is two or more consecutive blank new lines.

In one embodiment, one of the one or more file structure characteristics is three or more consecutive blank new lines.

In one embodiment, one of the one more file structure characteristics is the first line of content, which is taken as indicative of the file title.

In one embodiment, the method comprises the step of determining the length of the first line of content, with the first line of content taken as indicative of the section title where the length is less than about 100 characters.

In one embodiment, the first line of content does not comprise a natural term that is indicative of a non-title text.

In one embodiment, the natural word that is indicative of a non-title text, the natural term selected from the group consisting of “dedication”, “dedicate”, “acknowledgement”, “acknowledge”, “prologue”, “preface”, “foreword”, “introduction”, “index”, and “contents”, or linguistic equivalent thereof.

In one embodiment, the first line of each section is taken as indicative of the section title.

In one embodiment, the method comprises the step of determining the length of the first line of a section, with the first line taken as indicative of the section title where the length is less than about 50 characters.

In one embodiment, the method comprises removal of one or more tags which do not comply with a format of the target file.

In one embodiment, the source file is generated by a word processor.

In one embodiment, the method comprises the step of converting the source file to a marked up file before the step of analy+sing, the marked up file being the file analysed.

In one embodiment, the marked up file has predefined presentation semantics.

In one embodiment, the marked up file is an HTML or XHTML file.

In one embodiment, the method comprises removal of one or more tags which do not comply with a format of the target file.

In one embodiment, the marked up file is parsed to a database. In one embodiment, the method comprises the step of generating a file in a desired format.

In one embodiment, the desired format is an electronic book format.

In a second aspect the present invention provides software-executable code configured to, in use, perform the method as described herein.

In a third aspect, the present invention provides a computer-readable file produced by the method as described herein.

### BRIEF DESCRIPTION OF THE DRAWINGS

FIG. 1 is a diagram of a process flow of a preferred embodiment of the invention.

FIGS. 2 to 5 are document extracts from a .docx source file.

FIG. 6 is a page as displayed on an ebook reader, the page resulting from the conversion of the source file of FIGS. 2 to 5 into an ebook format.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

Applicant proposes that one or more problems of the prior art may be overcome or at least ameliorated by text conversion methods that do not have a strict reliance on embedded style tags within a source file. Accordingly in a first aspect the present invention provides a computer-implemented method for converting a source file having a first format into a target file having a second format, the method comprising the step of providing a source file, and analysing the source file to identify one or more file structure characteristics.

It has been found that text conversion can be reliably carried out without strict reliance on any tag(s) embedded within a source document. As will be appreciated from the Background section, the prior art conversion methods are reliant on an author carefully and deliberately formatting their work according to a predetermined style such that style tags are embedded in word processor file. By contrast, the present invention allows for an author to write more freely and without reference to a strict style guide while still being able to generate an acceptably formatted ebook from the word processor file. The analysis of a word processor file (being the source file of the method) may provide sufficient information to allow for entirely correct, less than entirely correct or at least acceptable identification of the various parts of a book, including the division of the book into chapters. Thus, the present invention is a significant departure from prior art conversion methods that must be provided with a properly tagged source file in order to accurately identify the various sections of a book, including the chapters.

In addition or alternatively to the advantages provided to the book author, in some embodiments the present methods may provide improved accuracy of conversion as compared with prior art methods. In the context of the present invention it will be understood that accuracy is intended to mean the faithful reproduction of the electronic document used to generate the source file to an electronic document from the converted file. The aspect of reproduction considered in this invention is primarily the faithful identification of book sections (such as chapters) and also secondary matters such as book title, section title and the like.

Accuracy may be measured by reference to the percentage of book sections correctly identified (such as the total of all book sections including the chapters, dedication, copyright page, index, foreword etc), or just the number of chapters correctly identified for a given document. For example, in a book having a copyright page, a dedication page, 10 chapters, and an epilogue (i.e. 13 sections in total), a prior art conversion method may correctly identify only the copyright page, Chapters 2 to 9 and the epilogue (the method incorrectly merging the dedication page and Chapter 1) to provide an accuracy of 77% while the present method may be an improvement by correctly delineating between the dedication section and Chapter 1 to give an accuracy of 85%. In some embodiments, the present methods are capable of accuracy of at least about 50, 60, 70, 80, 90%, or in some embodiments 100%.

Where the only consideration is the correct identification of all chapters in a source file, the accuracy of the present methods is at least about 90, 91, 92, 93, 94, 95, 96, 97, 98, 99%, or in some embodiments 100%.

Of course, the measurement of accuracy will be dependent to some extent on the nature of the source file, and may be measured by taking an average of a statistically significant number of randomly selected book source files.

At least one of the file structure characteristics may not be a style tag or a formatting, of the type embedded in a word processor document. Where a style tag or formatting tag is utilised in the present methods, it may be used in combination with a natural term of the source document, or in a manner to which the prior art is silent.

In the prior art, a series of heading levels is required for text conversion. For example, a top level may be termed heading1, the next level heading2, and so on. Designation of a title at the heading1 level (thereby automatically embedding a heading1 tag into the source file) may be routinely used by an author to indicate the chapter title (and therefore the start of a new chapter). Such tags may be utilised in the present methods, but importantly the present methods do not rely on such tags.

The present invention is distinguished by the exploitation of natural terms in the source document, which are not embedded tags. As used herein, the words “natural term” is intended to mean a word, a group of words, punctuation mark(s), space(s) and the like which are present in the source file and are intended to be comprehended by a human reader of the source file when displayed. Thus, a natural term may be a term which is used by an author in the normal course of writing. This is distinguished from tags, flags and other items embedded in the source file that are not intended for comprehension by a human reader.

In one embodiment, the file structure characteristic which are sought to be identified by the present method is a section break. A section brake may be a major break in the structure of a book such as the break before or after a title page, a copyright page, a dedication page, a foreword, a chapter, and the like. The ability to utilise file structure characteristics to identify a section break in a book is an advantage of the present invention which to the best of the Applicant's knowledge has not been disclosed in the prior art.

It has been found that page breaks in the source file are useful file structure characteristics in the present method. In particular, where a source file comprises 2, 3, 4, 5, 6, 7, 8, 9, 10 or more page breaks, then it is assumed by the method that page breaks have been used by the author to define book sections, such as chapters. Greater certainty for this assumption is provided where 3 or more pages breaks are found in the source file.

The contents of a new line or paragraph is considered to useful in the identification of section breaks of a book. As used herein, the term “new line” is intended to include a line generated by the author tapping the “enter” key of a computer keyboard. This act of tapping the “enter” key is taken as an indication of the method that a new section may be commenced. Searching the new line for certain keywords, and indentifying any keyword increases the level of certainty that the new line is the start of a new section. In particular, words such as “chapter”, “section”, “acknowledgement”, “dedication” and the like are indicative of the commencement of a new chapter, section, acknowledgement, or dedication section respectively. Given the benefit of the present specification the skilled is enabled to identify other keywords or terms useful in this regard.

Throughout this document it will be understood where the method relies on the presence or absence of an English language word, the equivalent word in any non-English language is taken to be an equivalent and therefore falls within the ambit of the invention. Other linguistic equivalents included variations of a word with a language (such as acknowledgement and acknowledgments, dedicate and dedication).

The presence of a cardinal or ordinal indicator in a new line or paragraph is also indicative that a new section has been commenced, this particularly so for the identification of the commencement of chapters. The cardinal or ordinal indicator may be a numeral (1, 2, 3; or roman numerals I, II, III) or a term such as “first” “second”, “third”, “1^{st}”, “2^{nd}”, “3^{rd}” etc. The present methods interprets the use of a cardinal or ordinal indicator on a new line as indicative of a new section being commenced in the book.

The method may have regard to the presence or absence of two or more consecutive blank new lines is further indicative of an author commencing a new section in a book. Two or more blank lines may be inserted by the author tapping the “enter” key twice (or more) in succession.

It will be appreciated from the above that there is described herein a number of means by which a section in a book may be identified by the presence or absence of:
1. Page Break
2. Heading Tag
3. New line or paragraph comprising a keyword
4. New line or paragraph that commences with a cardinal or ordinal indicator
5. Consecutive blank new lines.

With regard to points 1 to 5 listed supra, the method may comprise any 1, 2, 3, 4, or 5 means. Furthermore, any combination of any number of means 1 to 5 may be utilized.

In one embodiment, the method utilizes at least three of the means 1 to 5.

In one embodiment, the method comprises at least means 3, 4, and 5.

In one embodiment, the method potentially comprises each of means 1 to 5, but is carried out such that means 2 is only carried out if means 1 is negative, or means 3 is only carried out if means 2 is negative, or means 4 is only carried out if means 3 is negative, or means 5 is only carried out if means 4 is negative.

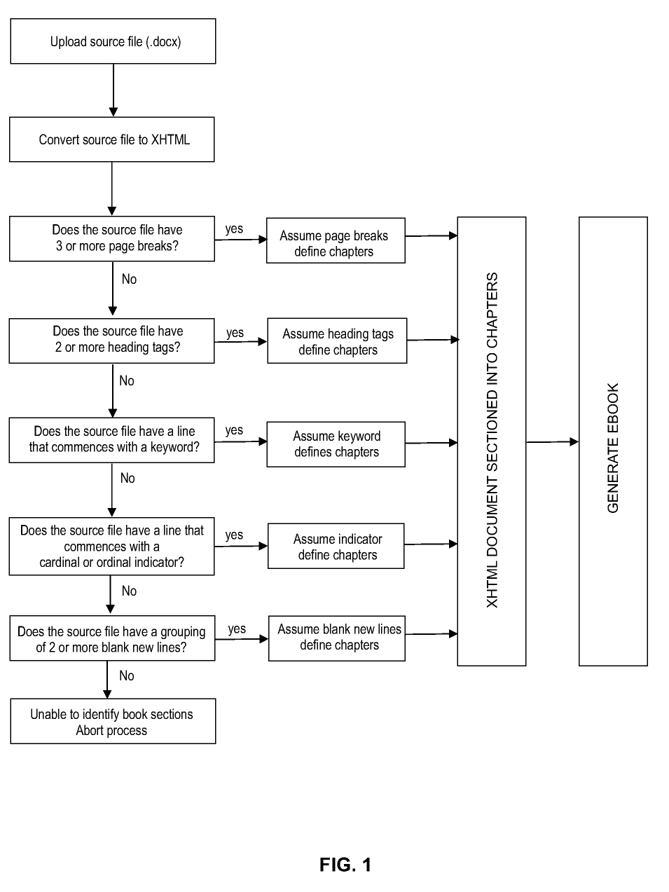

As will be apparent by reference to the preferred embodiment (and particularly the process diagram of FIG. 1), not all means may be necessarily executable in a method in order to section a book. For example, where the document has 3 or more page breaks it may be assumed that each and every page break signifies a division between chapters.

Accordingly, it may be unnecessary for the method to proceed with any further consideration (such as a search for heading tags, new lines with keywords, groups of blank new lines etc). While only a single means is utilized in that example, it will be appreciated however that more than a single means are nevertheless potentially used. Accordingly, a computer-implemented algorithm embodying the present method may contain means 1, 2, 3, 4, and 5, although not all means are necessarily executed in the course of sectioning a book.

Some means may be used as a primary screen, with others used additively to check the accuracy of the primary screen or to increase reliability. For example, a means useful as a primary screen may be based on the presence or absence of page breaks. Where page breaks are present, further means may be used to check the first lines of those sections. For example, the first lines might be searched for inclusion of the term “chapter” in which a positive result (at least for some sections) is indicative that chapters have been correctly identified. As another example, a section may be searched for the terms “dedication” and “acknowledgement” with the occurrence in a single section being indicative that the dedication page has been correctly identified. Where such checking provides negative outcomes, further means (such as the use of grouped blank new lines) may be further added to the method in an effort to improve conversion performance.

In the present methods, the source file is typically a word processing file (such as a file of extension type .doc, .docx, .txt, .rtf, or wpd file). The source file may, as an initial step, be converted to a .docx file format from any other word processor format.

The word processing file may be converted to XHTML format before analysis by the method. The skilled person is familiar with such conversion means, an example being the publicly accessible PHPDocx library (2mdc™, Madrid, Spain). The conversion may be performed on the computer executing the present method, or a remote computer in network communication therewith.

The title of the book may be determined by assessing the first line of substantive content. Non-substantive content is to be avoided. If the first line of substantive content is under about 100 characters in length and does not contain a collection of keywords such as ‘dedicate’, ‘dedication’, ‘acknowledge’, ‘acknowledgements’ and ‘foreword’, the method treats the first line of content as the title of the book. If the first line is over 100 characters or contains any of these words, the method uses the filename of the source file as the title.

The character count is used to determine that the text is not non-title text. Some authors open with a statement or paragraph and the keyword check is used to ensure that an opening section of a book (such as an introduction or foreword) is not mistakenly identified as a title.

The output file may be any electronic file type, but is preferably an ebook format such as OEBPS format (“epub”), eReader, FictionBook, iBook, KF8, Mobipocket, PDF, etc.

It will be understood that the steps of methods discussed herein are performed in one embodiment by an appropriate processor (or processors) of a processing (i.e., computer) system executing instructions (computer-readable code, computer-executable code) stored in storage. It will also be understood that the invention is not limited to any particular implementation or programming technique and that the invention may be implemented using any appropriate techniques for implementing the functionality described herein. The invention is not limited to any particular programming language or operating system.

Some of the embodiments are described herein as a method or combination of elements of a method that can be implemented by a processor or a processor device, computer system, or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

It will be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

The present invention will now be more fully described by reference to the following non-limiting examples.

### DETAILED DESCRIPTION OF A PREFERRED EMBODIMENT OF THE INVENTION

An exemplary method is shown at FIG. 1 which is a process diagram of a preferred method of the invention

The source document is of .docx format, and is firstly converted to XHTML format using PHPDocx library to provide an intermediate file.

The analysis commences with a search for 3 or page breaks in the intermediate file. If greater than 3 page breaks are identified, this indicates page breaks have been used by the author throughout the book as a method of forming chapter breaks. Accordingly, no further analysis is required to identify chapter breaks.

Where 0, 1 or 2 page breaks are identified, then the method searches the intermediate document for heading1 tags. If identified, the method assumes that each heading tag indicates the start of a new chapter. (e.g. “Chapter 1”, “Chapter 2” etc) Accordingly, no further analysis is required to identify chapter breaks.

Where no heading 1 tags are identified, the method searches the intermediate file for new lines that commence with the term “chapter”. If indentified, the method assumes that a new chapter commences at the point the word “chapter” appears. Accordingly, no further analysis is required to identify chapter breaks.

Where no new lines commence with the word “chapter” the method searches for new lines that commence with a cardinal or ordinal indicator. If identified, the method assumes that a new chapter commences at the point the numeral appears. For example, the author may have designated chapters thus: “1. The first chapter”. Accordingly, no further analysis is required to identify chapter breaks.

Where no new lines commence with a cardinal or ordinal indicator, the method searches for a group of three blank new lines. These new lines are considered a group where the author has tapped the enter key multiple times in order to designate the end of a chapter. If identified, the method assumes that a new chapter commences directly after the last new blank line.

Whichever of the above determinations are used to indentify chapter breaks, the first line of the chapter is taken as the chapter title. For example, where the new chapter commences with a numeral, the numeral and the following text is taken as the chapter title, pursuant to the putative title being less than about 50 characters in length. A further assessment of the putative title to identify non-title words such as “dedicate” and “copyright” is made to increase the reliability of the determination.

At this point, various sections of the book will be identified by the method, including the various chapters, a dedication page, and a copyright page.

The book title is determined by reference to the first line of substantive content. In this embodiment content which precedes the first line of substantive content is determined to be non-substantive, and is determined as such where words such as “dedicate”, “dedication”, “acknowledge”, “acknowledgements”, “copyright” and “foreword” are present. The presence of any one of these words is indicative of non-title text, and is this ignored in a search for the title. Upon identification of the first line of substantive text, the length of that line is determined and if more than 100 characters it is assumed by the method that it is non-title text. In that circumstance, the file name of the source file is taken to be the title.

After division into sections, the method removes any tags in the intermediate file which do not conform to the target file format. In this preferred embodiment, the target file must conform to ePub3 standards, and in which case font-family, background-colour, direction and unicode-bidi tags are removed.

A table of contents is generated based on the division of the book into sections by the method.

The book content (divided into chapters) is parsed into a database which is then used to generate the ebook file. Each chapter of book content is stored into a new row in a database. Typically, a relational database is used, such as PostgreSQL. Book content can then be readily displayed to the author (or end user) using Structured Query Language (SQL) for any further editing or review. The subsequent ebook is then generated from the database.

As will be appreciated, sections other than chapters may be identified by the method and parsed into the database, with each section being stored into a new row. For example, the database may have a row for the copyright section, a row for the dedication, and row for a post script in addition to chapter rows.

The numeric order of each chapter may also be stored in the database to provide a representation of the book's structure and to allow the user to modify the structure if necessary. The database may have a user interface by which to effect such amendments.

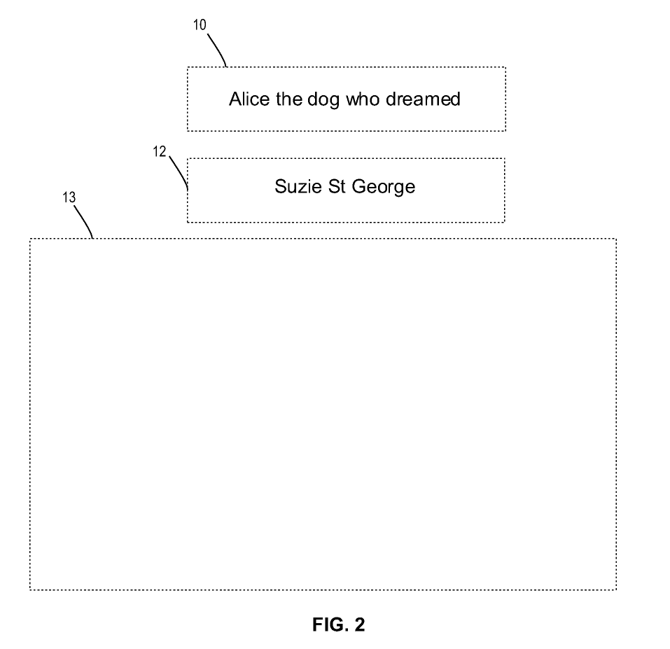

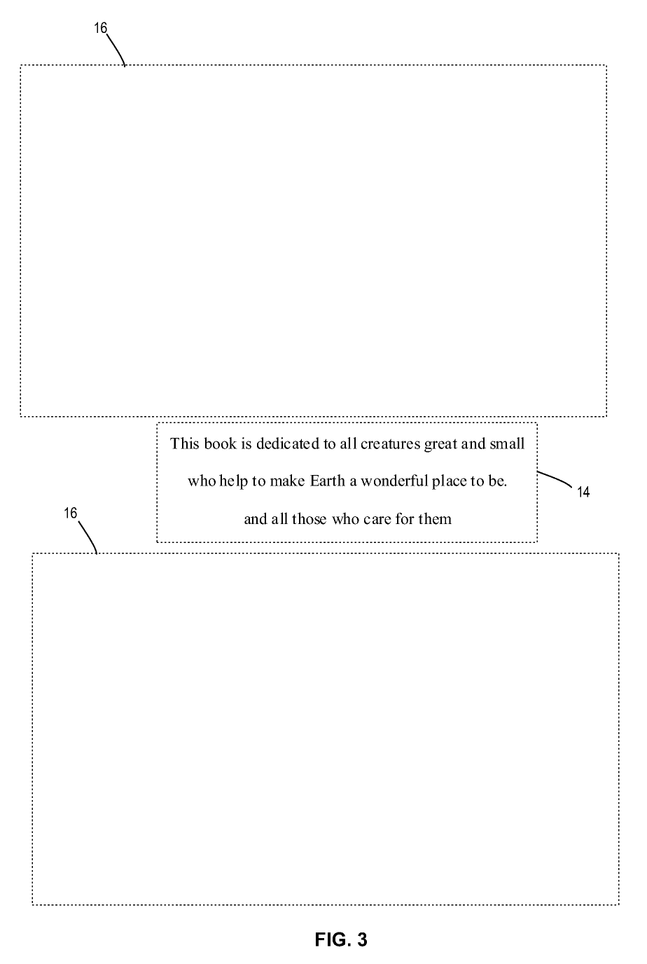

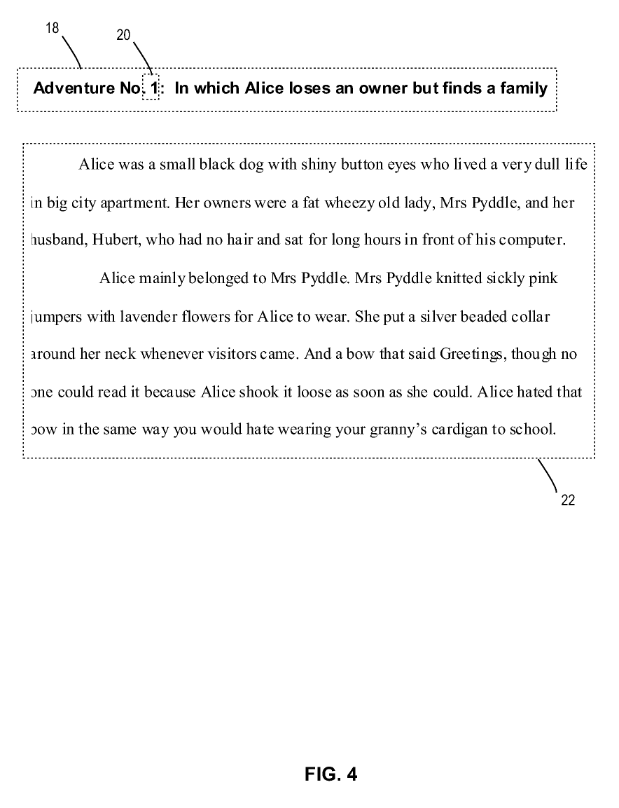

Turning now to FIGS. 2 to 5 there is shown parts of a source file, which is a .docx file of a story entitled “Alice the dog who dreamed”. While not unusual in any respect, the author of this story has utilized alternative means for designating the start of a new chapter. In particular, the chapters have been designated “adventures” by the author, this being to increase reader interest. No heading tags are embedded in the source file. There is a first page (FIG. 2) citing the title 10 and author 12, followed by the author's insertion of multiple new blank lines 13. On the following page is the dedication notice 14 (FIG. 3) which is unlabelled as such and placed in the middle of the second page by the insertion of multiple new blank lines 16, before commencing the first chapter (FIG. 4). The chapter title 18 has a numeral 20, with the body 22 of the chapter following.

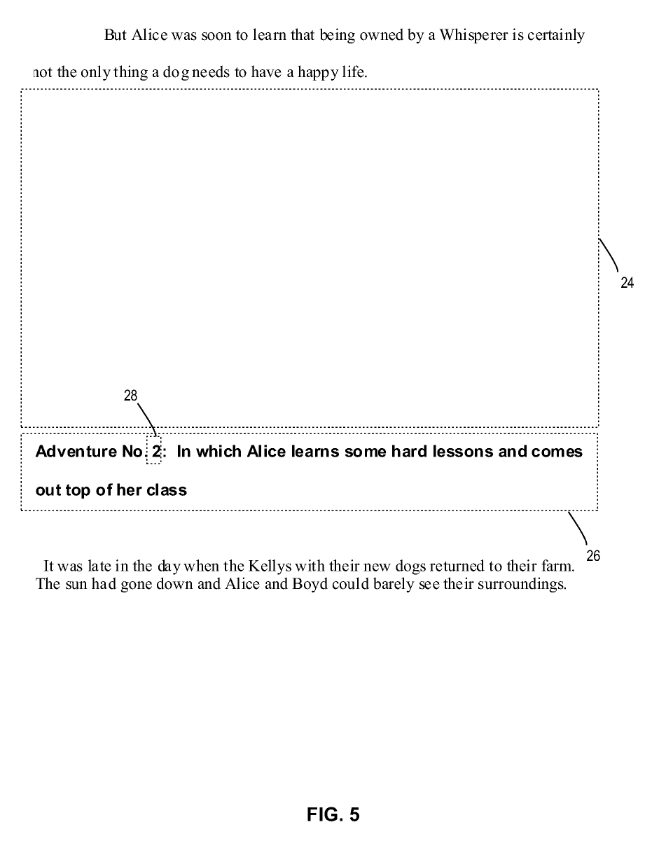

The end of the first chapter and the commencement of the second chapter is shown at FIG. 5. It will be noted that the author has inserted multiple new blank lines 24 before commencing chapter 2 with a title 26, the title including a numeral 28.

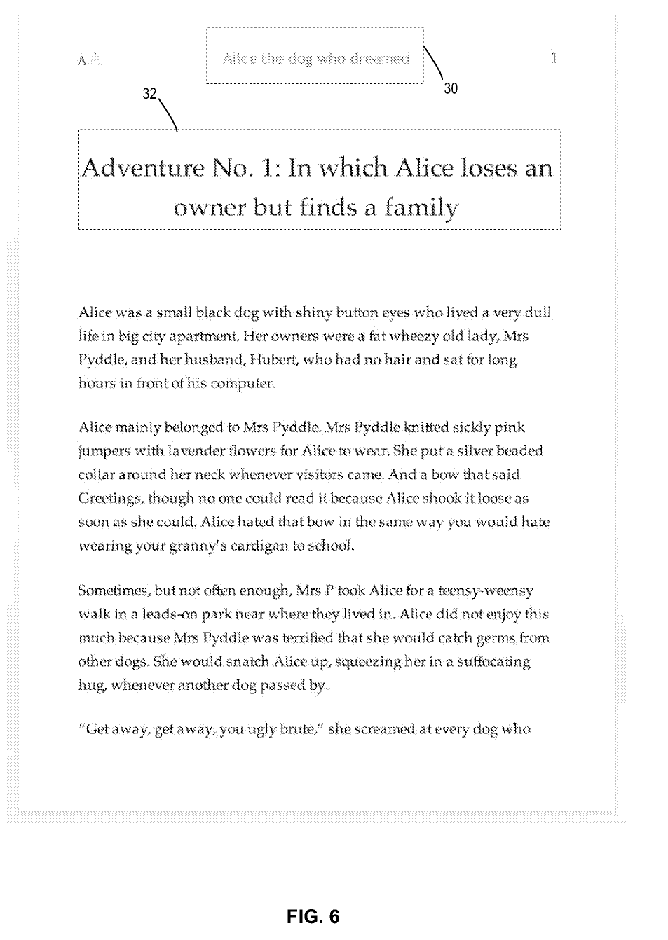

The output book is shown at FIG. 6, the book having a correctly indentified title 30 and chapter sectioning as shown by the successful identification of the chapter title 32.

In this embodiment, sections were indentified on the basis of the author's use of multiple new blank lines inserted between the end of a first section and the commencement of a second section. This allowed for the successful sectioning of the book between: (i) the title page and the dedication page, (ii) the dedication page and the first chapter, and (iii) the first chapter and the second chapter.

Alternatively, the source file could have been correctly sectioned also on the basis of the inclusion of a keyword on the first line of the dedication page (the word “dedication” being a keyword) this allowing section from the preceding title page and the following chapter page. This means would need to be combined with means whereby a new line is searched for a number in order to properly section the chapters.

The methods described herein may be deployed in part or in whole through a computer that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or may include a signal processor, digital processor, embedded processor, microprocessor or any variant such as a coprocessor (math co-processor, graphic co-processor, communication co-processor and the like) and the like that may directly or indirectly facilitate execution of program code or program instructions stored thereon. In addition, the processor may enable execution of multiple programs, threads, and codes.

The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere.

The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods described herein may be deployed in part or in whole through a computer that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, computers, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, computers, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon.

Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on computer readable media that may include: computer components, devices, and recording media that retain digital data used for computing for some interval of time;

semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks. Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods described herein may transform physical and/or or intangible items from one state to another. The methods described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on computers through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such computers may include, but may not be limited to, personal digital assistants, laptops, personal computers, mobile phones, other handheld computing devices, wired or wireless communication devices, transducers, chips, calculators, satellites, tablet PCs, electronic books, gadgets, electronic devices, devices having artificial intelligence, computing devices, networking equipment, servers, routers and the like.

Furthermore, the elements depicted in the flow chart and block diagrams or any other logical component may be implemented on a machine capable of executing program instructions. Thus, while the foregoing drawings and descriptions set forth functional aspects of the disclosed methods, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a computer readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method for converting a source file having a first format into a target file having a second format, the method comprising providing a source file, and analysing the source file to identify one or more file structure characteristics.

2. The method of claim 1 wherein one of the one or more file structure characteristics is a section break.

3. The method of claim 2 comprising searching the complete source file for the presence or absence of page breaks, wherein the section break is identified by the presence of 3 or more page breaks in the source file, with each of the 3 or more page breaks being taken as indicative of a section break.

4. The method of claim 3 wherein one of the one or more file structure characteristics is a top level heading tag embedded in the source file.

5. The method of claim 1 wherein one of the one or more file structure characteristics is a new line or a paragraph commencing with or comprising a natural term that is indicative of a section break.

6. The method of claim 1 wherein one of the one or more file structure characteristics is a new line or a paragraph commencing with or comprising a cardinal or ordinal indicator that is indicative of a section break.

7. The method of claim 1 wherein one of the one or more file structure characteristics is two or more consecutive blank new lines.

8. The method of claim 1 wherein one of the one more file structure characteristics is the first line of content, which is taken as indicative of the file title.

9. The method of claim 8 comprising determining the length of the first line of content, with the first line of content taken as indicative of the section title where the length is less than about 100 characters.

10. The method of claim 8 wherein the first line of content does not comprise a natural term that is indicative of a non-title text.

11. The method of claim 1 wherein the first line of each section is taken as indicative of the section title.

12. The method of claim 11 comprising determining the length of the first line of a section, with the first line taken as indicative of the section title where the length is less than about 50 characters.

13. The method of claim 1 comprising removal of one or more tags which do not comply with a format of the target file.

14. The method of claim 1 wherein the source file is generated by a word processor.

15. The method of claim 1 comprising converting the source file to a marked up file before the act of analysing, the marked up file being the file analysed.

16. The method of claim 15 wherein the marked up file has predefined presentation semantics.

17. The method of claim 15 wherein the marked up file is parsed to a database.

18. The method of claim 1 comprising generating a file in an electronic book format.

19. A non-transitory computer-readable medium comprising software executable code stored thereon, which when executed by a processor configure the processor to perform acts of:
converting a source file having a first format into a target file having a second format, comprising:
providing a source file, and
analysing the source file to identify one or more file structure characteristics.

20. (canceled)
